(19) United States
(12) Patent Application Publication
(10) Pub. No.: US 2025/0180154 A1
(43) Pub. Date: Jun. 5, 2025

(54) Platform Rocker and Motions Performed Therewith

(71) Applicant: Forward Biotech, Inc., Troy, NY (US)

(72) Inventor: Ian K. Glasgow, Averill Park, NY (US)

(21) Appl. No.: 18/961,724

(22) Filed: Nov. 27, 2024

Related U.S. Application Data
(60) Provisional application No. 63/605,232, filed on Dec. 1, 2023.

(51) Int. Cl. F16M 11/10; F16M 11/18

(52) U.S. Cl. CPC F16M 11/10; F16M 11/18

(57) ABSTRACT

A tiltable platform device having a base and a tiltable platform mounted to the base as well as a method of moving the tiltable platform during a process and the corresponding motions thereof. A control unit is configured to move the tiltable platform in a specified pattern as part of a process. The specified pattern can include settings corresponding to each of a plurality of steps, where each step includes user selectable settings. The user selectable settings of the step can include a target tilt angle and a rate of change when transitioning from a current tilt angle to the target tilt angle. The user selectable settings can be independently selectable for each step.

### REFERENCE TO RELATED APPLICATIONS

The current application claims the benefit of U.S. Provisional Application No. 63/605,232, filed on 1 Dec. 2023, which is hereby incorporated by reference.

### TECHNICAL FIELD

The disclosure relates generally to platform rockers, and more particularly, to a platform rocker capable of performing additional motions.

### BACKGROUND ART

Platform rockers are mainly used for keeping experimental fluids flowing or mixing, such as for incubation and washing steps with blots and DNA hybridization.

Many laboratories culture cells in microfluidic channels, such as for tissue growth. Often, there is a desire to flow culture medium past the cells during culturing. For example, lab grown tissues and organoids are increasingly replacing animal testing. In three dimensional culture systems, controlling the flow of the culture medium often leads to better growth of the tissues and organoids. In fact, the inventor of this patent has demonstrated this in culturing pre-implantation embryos over two decades ago.

Pumps are commonly used to control the flow of culture medium. However, for accurate control in every channel, pumped flow systems require a separate pump for every channel. In addition, an air bubble in the system, while traveling past the tissue or organoid, can leave the tissue or organoid without culture medium. As a result, tubing connections made between the pump and the culture plate must be done without entrapping air. This is a tedious process for every connection.

For these reasons, gravity driven flow systems provided by the platform rockers remain popular. Tilting a culture plate forces the culture medium to flow downhill, from the higher end to the lower end. A culture plate with 6, 32, or even 128 sets of channels and culture chambers requires only a single platform rocker rather than 12, 64, or 256 separate pump lines. In fact, multiple plates can be placed on a single platform rocker. Secondly, because the system can remain open to the atmosphere, rather than a closed system, entrapment of air is not an issue. Air can remain above the culture medium in the reservoirs, without being forced into the channels or past the culture, such as tissue or organoids.

When using gravity, it is usually desired to reverse the direction of flow periodically, to reuse the medium. Some platform rockers can perform a continuous punctuated cycle, such as in a sinusoidal fashion, which can include moving to a tilt angle, dwelling at the tilt angle for a period of time, moving to a reverse tilt angle, and dwelling at the reverse tilt angle for a period of time. The punctuated cycle can be repeated. However, to date, such rockers are limited in function and are derived from existing rocker technology.

### SUMMARY OF THE INVENTION

The inventor proposes a platform rocker that provides one or more new and useful features and benefits. Embodiments of the platform rocker can enable better control of the flow of the medium, include an easier to use control interface, provide an ability to run more complex cycles, have a more flexible manufacturing procedure, and/or the like.

A tiltable platform device having a base and a tiltable platform mounted to the base as well as a method of moving the tiltable platform during a process and the corresponding motions thereof are described herein. The device can include a control unit, which is configured to move the tiltable platform in a specified pattern as part of a process. The specified pattern can include settings corresponding to each of a plurality of steps, where each step includes user selectable settings. The user selectable settings of the step can include a target tilt angle and a rate of change when transitioning from a current tilt angle to the target tilt angle. The user selectable settings can be independently selectable for each step.

Embodiments provide a platform rocker that can have continuous perfusion flow at a slow, constant rate or a pulsatile flow that mimics the flow created by a beating heart.

For a slow, constant flow rate, the platform needs to travel to a small angle and remain there. For a constant flow rate for an extended time period, the tilt angle of the platform has to increase slowly to maintain the height difference between the surfaces of the culture medium in the source reservoir and in the waste reservoir. As the medium flows from the source reservoir, perfuses past a culture (e.g., an organoid), and travels to the waste reservoir, the height of the medium surface in the source reservoir goes down while the height of the medium surface in the waste reservoir goes up. To compensate for this effect, e.g., so that the flow rate remains constant, the platform can have its tilt angle gradually increased.

Likewise, mimicking pulsatile flow requires a platform rocker capable of implementing advanced platform motions, so that the platform can pulse from a resting position to a steep tilt angle. Advanced rockers also can enable flow control of the medium to cause, for example, a desired shear stress on a culture (e.g., cells).

Embodiments include a device with a tiltable platform that can be accurately controlled and easily programmed. Such a configuration can enable users to better control the flow of culture medium for perfusion systems, such as cell culture and in vitro fertilization systems, etc. Embodiments of a system including a device with a tiltable platform can enable scientists to research the effects of one or more parameters, such as flow rate, and thus optimize the parameter(s) for the best results. Embodiments of a device including the tiltable platform also can be used for other applications that require tilting including, for example, gravity controlled fluidic systems, systems in which objects are controlled by tilting to travel through channels, etc.

Aspects of the invention provide a device with a tiltable platform capable of performing various motions to change an angle of the tiltable platform and/or hold the tiltable platform at a particular angle. The tiltable platform can be configured to support cartridges and other components in which the tilt angle can be easily and accurately controlled.

In an illustrative embodiment, a device for controlling the tilt angle of a platform supporting one or more cartridges is described. Embodiments of the device can include a base and a platform mounted to the base in a manner that enables motion of the platform along at least one axis. The motion can be implemented by a motor. the motion can be controlled by a control unit, which is configured to implement an experiment which includes the motion. Embodiments of the device can include a motor, a transmission, a platform, a base, and a user control unit. In embodiments, the movement of the platform is driven by a motor with accurate shaft rotation control, such as a stepper motor or a motor with an encoder, which can drive a transmission for mechanical advantage and increased tilt angle accuracy of the attached platform. One or more sensors can monitor the tilt angle of the platform, to enable the control system to accurately control the tilt angle. It is understood that further embodiments can be implemented with additional components, fewer components, comparable components, etc.

In embodiments, the control system can be configured to hold the platform at specific tilt angles. The control system can move the platform at different rates for different parts of a cycle. In embodiments, the control system can cause the platform to travel at very slow rates, which can enable fine adjustment to affect one or more parameters of an experiment.

A first aspect of the invention provides a device comprising: a base; a tiltable platform mounted to the base; and a control unit configured to direct movement of the tiltable platform in a specified pattern as part of a process, wherein the specified pattern includes settings corresponding to each of a plurality of steps, each step having user selectable settings including a target tilt angle and a rate of change when transitioning from a current tilt angle to the target tilt angle, wherein the user selectable settings are independently selectable for each step.

A second aspect of the invention provides a device comprising: a base; a tiltable platform mounted to the base, wherein the tiltable platform is configured to support at least one structure including a pair of wells and a channel enabling flow of a medium between the pair of wells; and a control unit configured to direct movement of the tiltable platform in a specified pattern as part of a process, wherein the specified pattern includes a plurality of steps configured to affect the flow of the medium in the channel during the process, the plurality of steps including: a first step having a first starting tilt angle, a first target tilt angle, and a first rate of change when transitioning from the first starting tilt angle to the first target tilt angle; and a second step having a second starting tilt angle, a second target tilt angle, and a second rate of change when transitioning from the second starting tilt angle to the second target tilt angle; wherein at least one of: the first starting tilt angle differs from the second target tilt angle, the first target tilt angle differs from the second starting tilt angle, or the first rate of change differs from the second rate of change.

A third aspect of the invention provides a method of performing a process, the method comprising: a control unit directing movement of a tiltable platform supporting a structure in a specified pattern as part of the process, the structure including a pair of wells and a channel enabling flow of a medium between the pair of wells; wherein the specified pattern includes a plurality of steps configured to affect the flow of the medium in the channel during the process, the plurality of steps including: a first step having a first starting tilt angle, a first target tilt angle, and a first rate of change when transitioning from the first starting tilt angle to the first target tilt angle; and a second step having a second starting tilt angle, a second target tilt angle, and a second rate of change when transitioning from the second starting tilt angle to the second target tilt angle; wherein at least one of: the first starting tilt angle differs from the second target tilt angle, the first target tilt angle differs from the second starting tilt angle, or the first rate of change differs from the second rate of change.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative platform rocker device according to an embodiment.

FIG. 2 shows internal components of a base of an illustrative platform rocker device according to an embodiment.

FIGS. 3A-3D show illustrative effects on a medium due to movement of the platform according to an embodiment.

FIGS. 4A and 4B show illustrative tilt angle motion patterns according to embodiments.

FIG. 5 shows an illustrative tilt angle motion pattern according to an embodiment.

FIGS. 6A and 6B show a platform rocker at two different tilt angles according to embodiments.

FIG. 7 shows an illustrative tilt angle motion pattern according to an embodiment.

FIGS. 8A and 8B show a platform rocker at two different tilt angles according to embodiments.

FIG. 9 shows an illustrative tilt angle motion pattern according to an embodiment.

FIG. 10 shows another illustrative configuration for creating tilt angle motion patterns according to embodiments.

FIGS. 11A and 11B show another illustrative configuration for creating tilt angles for a platform along two axes according to embodiments.

FIG. 12 shows an illustrative two axis tilt angle motion pattern according to embodiments.

FIGS. 13A and 13B show illustrative process data defining a process including motion between two axis tilt angles according to embodiments.

FIG. 14 shows a schematic of various components of an illustrative platform rocker device according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

A tiltable platform device having a base and a tiltable platform mounted to the base as well as a method of moving the tiltable platform during a process and the corresponding motions thereof are described. A control unit is configured to move the tiltable platform in a specified pattern as part of a process. The specified pattern can include settings corresponding to each of a plurality of cycles, where each cycle can include at least one step with user selectable settings. The user selectable settings of the step can include a target tilt angle and a rate of change when transitioning from a current tilt angle to the target tilt angle. The user selectable settings can be independently selectable for each step.

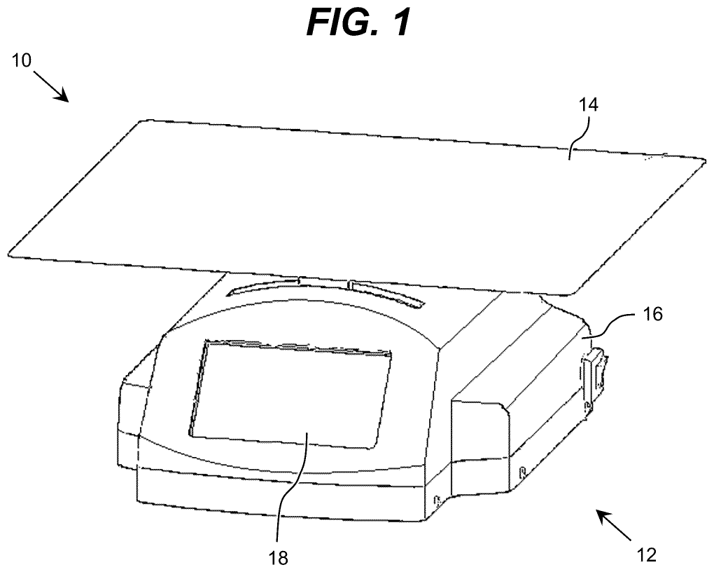

Turning to the drawings, FIG. 1 shows an illustrative platform rocker device 10 according to an embodiment. The platform rocker device 10 can include a base 12, which supports a platform 14. The base 12 can comprise various components that enable the platform 14 to be moved in a controlled manner. For example, the base 12 can be configured to move the platform 14 in a side-to-side rocking motion. Such a rocking motion can cause the platform 14 to tilt to one side or the other.

The base 12 is shown including a housing 16 which can cover and protect various components located therein. The components can include a user interface 18, such as a touchscreen, which can enable a user to input and/or view a desired motion, motion parameters, status, etc.

While the user interface 18 is illustrated as enabling a human user to interface with the platform rocker device 10, it is understood that embodiments of the user interface 18 can be configured for interfacing with another computing device or computer system. In either case, the user interface can enable a user (human or another computer) to direct operation of the platform rocker device 10.

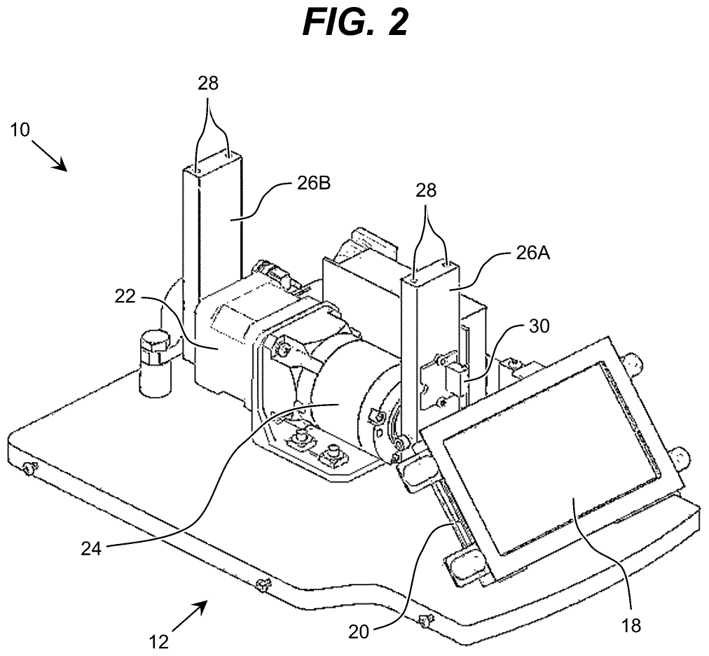

FIG. 2 shows internal components of a base 12 of an illustrative platform rocker device 10 according to an embodiment. For example, the internal components can correspond to internal components of the platform rocker device 10 shown in FIG. 1.

The components can include a control component 20, which can be implemented as a circuit board or the like, and which is shown located behind the user interface 18. The control component 20 can send and receive data via the user interface 18 and operate a motor 22 to direct movement of the platform 14 (FIG. 1) according to operating information received by the user interface 18 and/or program instructions stored on the control component 20.

It is understood that a circuit board is only illustrative of any of various computing units which can be used to implement the control component 20 of the platform rocker device 10 described herein. In embodiments, some or all of the processing for moving the platform 14 (FIG. 1) as described herein can be performed on a computer system located external to the platform rocker device 10. In this case, the computer system can communicate with the control component 20 using any solution in order to direct operation of the motor 22 to accomplish the desired motion. To this extent, such communication can use any combination of optical fiber, wired, and/or wireless links; utilize any combination of one or more types of networks; and/or utilize any combination of various types of transmission techniques and protocols. In an embodiment, a software application executing on an external computing device, such as a handheld computing device, can enable the handheld computing device to control operation of the platform rocker device 10 and/or receive information regarding the operation of the platform rocker device 10. For example, such information can include a progress of an experiment, one or more measurements acquired during the experiment, an alert due to a malfunction, etc.

The control component 20 can be configured to direct the motor 22 to move the platform 14 in a side-to-side rocking motion, thereby adjusting a tilt angle of the platform 14 in an automated, semi-automated, and/or manual process. In embodiments, the motor 22 can comprise a variable speed motor 22, which can include a shaft and/or a corresponding flange that can be rotated in either direction, clockwise or counter clockwise. In embodiments, the motor 22 can comprise accurate shaft rotation control. For example, the motor 22 can comprise a stepper motor, a motor with an encoder which drives a transmission, and/or the like.

The platform rocker device 10 is shown including two arms 26A, 26B on which the platform 14 can be mounted. The motor 22 is shown connected to a gear box 24 which can drive motion of a front arm 26A. The motion can include side-to-side motion described herein. In embodiments, motion of a rear arm 26B follows that of the front arm 26A. However, it is understood that this configuration is only illustrative of various possible configurations for driving the motion of the arms 26A, 26B.

The platform 14 can be attached to the front arm 26A and the rear arm 26B using any permanent or removable solution. In embodiments, the platform 14 can be attached to the arms 26A, 26B using bolts which can be inserted by turning into complementary threaded mounting holes 28. However, it is understood that this solution is only illustrative of various solutions for attaching the platform 14 to the arms 26A, 26B.

Regardless, in embodiments, the control component 20 can operate the motor 22 to adjust the tilt angle of the platform 14 according to a predefined process or user defined process. To this extent, a user can instruct the control component 20 to follow a desired process in order to adjust the tilt angle of the platform 14 in a desired manner. In embodiments, the control component 20 can be pre-configured with a selectable set of programmed processes. In embodiments, a user can provide a new programmed process or modify an existing programmed process for execution by the control component 20 using the user interface 18.

In embodiments, the platform rocker device 10 can include one or more sensing devices, each of which can be configured to provide data for processing by the control component 20 and use during execution of a process. For example, a sensing device 30, such as an accelerometer, is shown attached to the front arm 26A. The sensing device 30 can be configured to acquire data corresponding to an angle of the front arm 24A, which can be provided for processing by the control component 20. The control component 20 can use data received from the sensing device 30 to determine one or more attributes of the platform 14. For example, the control component 20 can process the data corresponding to the angle of the arm 26A to calculate an angle of the platform 14.

It is understood that the sensing device 30 is only illustrative of various possible types and/or configurations of sensing devices that can be implemented in the platform rocker device 10. To this extent, a sensing device described herein can be configured to sense one or more attributes of a corresponding arm 26A, 26B, the platform 14, the base 12, etc. Information received by the control component 20 from the sensing device(s) 30 can be used to accurately perform the specified process.

Additionally, one or more sensing devices can be configured to provide other types of sensing data. For example, the platform rocker device 10 can include one or more sensing devices configured to acquire information regarding an ambient environment, such as temperature, humidity, light intensity, etc. Additionally, the platform rocker device 10 can include one or more sensing devices configured to acquire information on the platform 14, such as a current angle, a current rate of change of the angle, and/or the like. The platform rocker device 10 also can include one or more sensing devices to acquire information on the base 12, such as one or more angles of a spatial orientation of the base 12. Still further, the control component 20 can be configured to acquire information regarding one or more experiments being conducted on the platform 14. To this extent, the platform rocker device 10 can include an imaging device (e.g., infrared, near infrared, visible, and/or the like), which can acquire image data for an experiment located on the platform 14.

Similarly, components placed on the platform 14 for the experiment can be configured to interface with the control component 20 to provide any of various types of information on the experiment, such as a direction/rate of flow of a culture medium, a color of a culture, a temperature, etc. In embodiments, the platform 14 can comprise an at least partially contained environment for an experiment located thereon. In this case, the platform 14 and/or one or more components of the experiment located within the at least partially contained environment can comprise one or more components (e.g., output devices, sensors, etc.), which operate independently and/or which the control component 20 can operate to affect the environment, obtain data regarding the environment, and/or the like. In embodiments, the platform rocker device 10 can be placed in and operate in a larger controlled environment, such as a carbon dioxide cell culture incubator.

As discussed herein, the platform rocker device 10 can be used to conduct any of various processes during which a medium located on the platform 14 can be moved side to side in a manner that changes an angle of the platform 14 and the medium located thereon. In more particular illustrative embodiments, a process is implemented using one or more structures located on the platform 14, each structure comprising at least two reservoirs for holding the medium therein and a channel enabling flow of the medium from a first reservoir to a second reservoir. The reservoirs can be oriented on the platform 14 such that the channel located therebetween is aligned with the direction of the side to side motion.

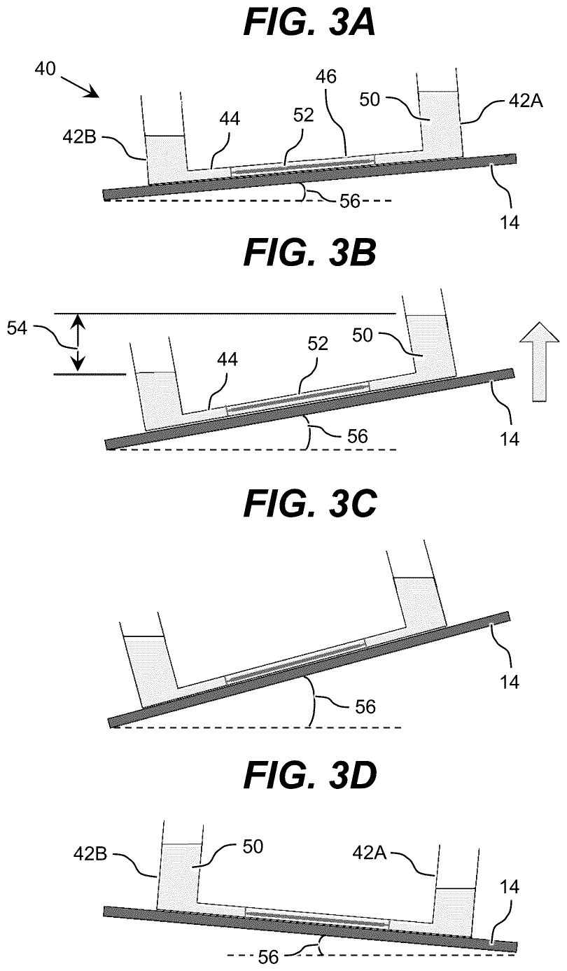

FIGS. 3A-3D show illustrative effects on a medium due to movement of the platform 14 according to an embodiment. In FIGS. 3A-3D, the platform 14 of the platform rocker device 10 is shown including a structure 40, which can comprise, for example, a microfluidic culture plate, located on the platform 14. The structure 40 is shown including a pair of wells 42A, 42B with a medium 50, such as a culture medium, located therein. As an example, the medium 50 can be initially placed in the well 42A, which can be referred to as a source well. During operation of the platform rocker device 10, the medium 50 can travel through a channel 44, such as a microfluidic channel, and into the well 42B, which can be referred to as a collection well. For certain processes, the channel 44 can include a chamber 46 within which an experiment can be conducted. For example, a culture 52, such as a cell culture, can be located within the chamber 46 such that the medium 50 will flow past the culture 52 as it flows through the channel 44. It is understood that a structure 40 can include many pairs of wells 42A, 42B with a channel 44 and/or a chamber 46 located there between. However, for clarity, only a single pair is illustrated herein.

As shown in FIG. 3B, there will be a difference in height 54 between an upper surface of the medium 50 located in the source well 42A and an upper surface of the medium 50 located in the collection well 42B. The difference in height 54 causes the medium 50 to flow through the channel 44, past the culture 52. The difference in height 54 affects a rate of flow for the medium 50 within the channel 44 as it passes the culture 52. In particular, a larger difference in height 54 will result in a greater rate of flow for the medium 50 through the channel 44. When the platform 14 is held at a constant tilt angle 56, as the medium 50 flows from the source well 42A to the collection well 42B, the difference in volume of the medium 50 in the wells 42A, 42B decreases, and thus the difference in height 54 will also decrease. The decrease in the difference in height 54 will result in a slower flow rate for the medium 50 within the channel 44 and past the cell culture 52.

In embodiments, as illustrated by FIGS. 3A-3C, the platform rocker device 10 can change the tilt angle 56 of the platform 14 to affect the difference in height 54. For example, as illustrated in FIG. 2, the control component 20 can operate the motor 22 which in turn operates the gear box 24 to move the front arm 26A in a desired direction and at a desired rate. As described herein, the control component 20 can use data received from the motor 22, one or more sensing devices 30, and/or the like, to control the movement of the front arm 26A in a precise manner.

In more particular embodiments, the control component 20 can operate the motor 22 to cause the tilt angle 56 of the platform 14 to change to at least partially compensate for a change in the difference in height 54 as the medium 50 flows from the source well 42A, through the channel 44, and into the collection well 42B. In more particular embodiments, the platform rocker device 10 can adjust the tilt angle 56 of the platform 14 to maintain a substantially constant difference in height 54 as the medium 50 flows.

In embodiments, the platform rocker device 10 can adjust the tilt angle 56 to have any desired effect on the rate of flow of the medium 50 through the channel 44. To this extent, adjustments to the tilt angle of the platform 14 can be configured to result in an increase in the rate of flow of the medium 50, a decrease in the rate of flow of the medium 50, a substantially constant rate of flow of the medium 50, and/or the like.

When the structure 40 comprises a microfluidic culture plate or similar structure, the difference in height 54 may start at several millimeters and decrease over time. The platform rocker device 10 can move the platform 14 in a manner that causes a very slow change in the tilt angle 56 of the platform 14, which can maintain the difference in height 54 at a relatively constant difference. In more particular embodiments, a microfluidic culture plate may have an initial difference in height 54 of approximately four millimeters, which the platform rocker device 10 can maintain by increasing the tilt angle 56 of the platform 14 at a rate of approximately fifteen degrees over a period of approximately twenty minutes. However, it is understood that this difference in height 54 and tilt angle 56 rate of change are only illustrative of various possible differences and rates of change for a structure 40 and medium 50 which can be located on the platform 14. For example, in embodiments the difference in height 54 can be as little as a fraction of a millimeter, and as much as several centimeters.

During operation, the platform rocker device 10 may tilt the platform 14 to a maximum possible tilt angle 56 for the platform 14. Similarly, the medium 50 may flow nearly or completely out of the source well 42A. To this extent, the platform rocker device 10 can adjust the tilt angle 56 of the platform 14 so that the flow of the medium 50 reverses. In particular, as shown in FIG. 3D, the tilt angle 56 of the platform 14 can be such that the medium 50 flows from the collection well 42B to the source well 42A. For convenience, tilt angles 56 such as those shown in FIGS. 3A-3C can be considered a positive tilt angles 56, while the tilt angle 56 shown in FIG. 3D can be considered a negative tilt angle 56.

In embodiments, the platform rocker device 10 can adjust the tilt angle 56 of the platform 14 to change the direction of the flow of the medium 50 at a relatively high rate of change, e.g., to create a high shear to promote unidirectional growth of a culture 52, such as epithelial or endothelial cells. Subsequently, the platform rocker device 10 can adjust the tilt angle 56 of the platform 14, e.g., at a relatively slow rate of change, to have any desired effect on the rate of flow of the medium 50 through the channel 44 as described herein. During a typical experiment, adjustments of the tilt angle 56 of the platform 14 (e.g., between positive and negative tilt angles 56) can change the direction of flow of the medium 50 within the channel 44 multiple times, e.g., by repeating a cycle.

As described further herein, the platform rocker device 10 can adjust the tilt angle 54 of the platform 14 according to any of various defined motion patterns. In embodiments, a motion pattern can include a plurality of cycles, where each cycle includes a plurality of motion instructions for implementation by the platform rocker device 10, which are repeated during each of the plurality of cycles. In embodiments, a motion pattern can further include a plurality of stages, where each stage is defined by one or more cycles. In this case, the motion pattern can change after each stage, which implements one or more motion cycles for a defined number of cycles, a defined duration, and/or the like.

Embodiments of the platform rocker device 10 described herein can be configured to selectively implement such defined motion patterns. In embodiments, a user (e.g., via the user interface 18 of FIG. 1), can selectively adjust the maximum tilt angle 56, the minimum tilt angle (e.g., the maximum negative tilt angle 56), an amount of time to travel between the maximum and minimum tilt angles 56 (e.g., a half cycle), an amount of time between reaching consecutive maximum or minimum tilt angles 56 (e.g., a full cycle), a number of cycles, a duration for the motion to continue, and/or the like. In embodiments, the platform rocker device 10 can include predefined motion patterns that can be selected by the user, enable custom motion patterns to be defined by the user (e.g., which can be subsequently saved as a predefined motion pattern for later use), and/or the like. In embodiments, a predefined motion pattern can include one or more variables, which can be selectively modified by the user, such as maximum/minimum tilt angles 56, duration (e.g., expressed in time, a number of cycles, or the like), etc.

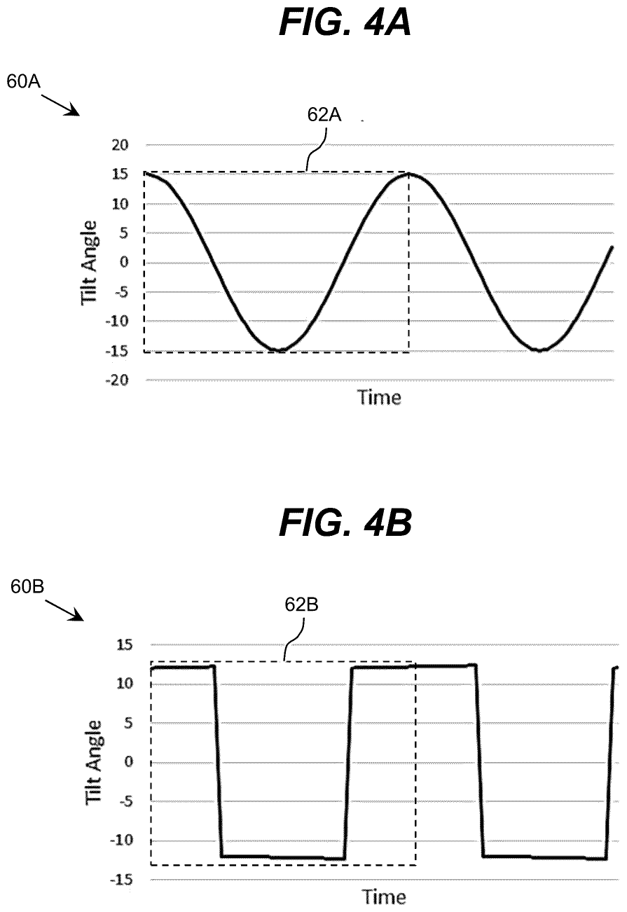

FIGS. 4A and 4B show illustrative tilt angle motion patterns 60A, 60B, which can be implemented by the platform rocker device 10, according to embodiments. Referring to FIGS. 3A-4B, FIG. 4A shows an approximately sinusoidal tilt angle motion pattern 60A over time for a tilt angle 56 of a platform 14 according to an embodiment. The tilt angle motion pattern 60A is similar to motion that can be implemented on a typical laboratory rocker. The tilt angle motion pattern 60A can cause an approximately sinusoidal flow rate of a medium 50 within a structure 40 located on the platform 14 with time.

In particular, as illustrated, the tilt angle 56 can be changed between a maximum positive tilt angle 56 (e.g., 15 degrees) and a minimum tilt angle 56, or maximum negative tilt angle 56, (e.g., −15 degrees) over an arbitrary amount of time. In this case, a cycle 62A can include a time period required to complete one full motion of the tilt angle 56 changes, e.g., starting from the maximum positive tilt angle 56 and ending when the tilt angle 56 returns to the maximum positive tilt angle 56. While not shown in FIG. 4A, such a cycle 62A can be repeated in the tilt angle motion pattern 60A any number of times for any duration, such as a designated number of cycles 62A, a designated time period, and/or the like.

FIG. 4B shows another illustrative tilt angle motion pattern 60B of a platform 14, which can be implemented by the by the platform rocker device 10, according to another embodiment. In this case, the motion of the platform 14 will cause a medium 50 to have a constant flow rate in one direction, then quickly change to a constant flow rate in the opposite direction. Such motion can better mimic in vivo conditions for many applications. As illustrated, the tilt angle motion pattern 60B can include a slight increase in tilt angle over time in each cycle 62B. Such an increase can, for example, compensate for a decrease over time in a difference in height 54 between the medium 50 located in the source well 42A and the medium 50 located in the collection well 42B, e.g., due to a gravity-induced flow of the medium 50 between the source well 42A and the collection well 42B, thereby providing a gravity-induced flow of the medium 50 having a substantially constant rate of flow.

As illustrated in FIG. 4B, the tilt angle motion pattern 60B can include a relatively rapid change between a positive and negative tilt angle 56 for the platform 14, which is subsequently followed by a relatively slow change from an initial positive/negative tilt angle 56 reached immediately after the change, to a maximum positive/negative tilt angle 56 before another relatively rapid change. It is understood that the particular angles, rates of change, etc., can be selectively modified according to attributes of the medium 50, the structure 40 located on the platform 14, and the desired attributes for the process (e.g., a desired flow rate of the medium).

While the cycles 62A, 62B shown in FIGS. 4A and 4B are generally symmetric with respect to a tilt angle 56 of zero and about a half cycle, it is understood that the platform rocker device 10 can implement tilt angle motion patterns with cycles that are not symmetrical.

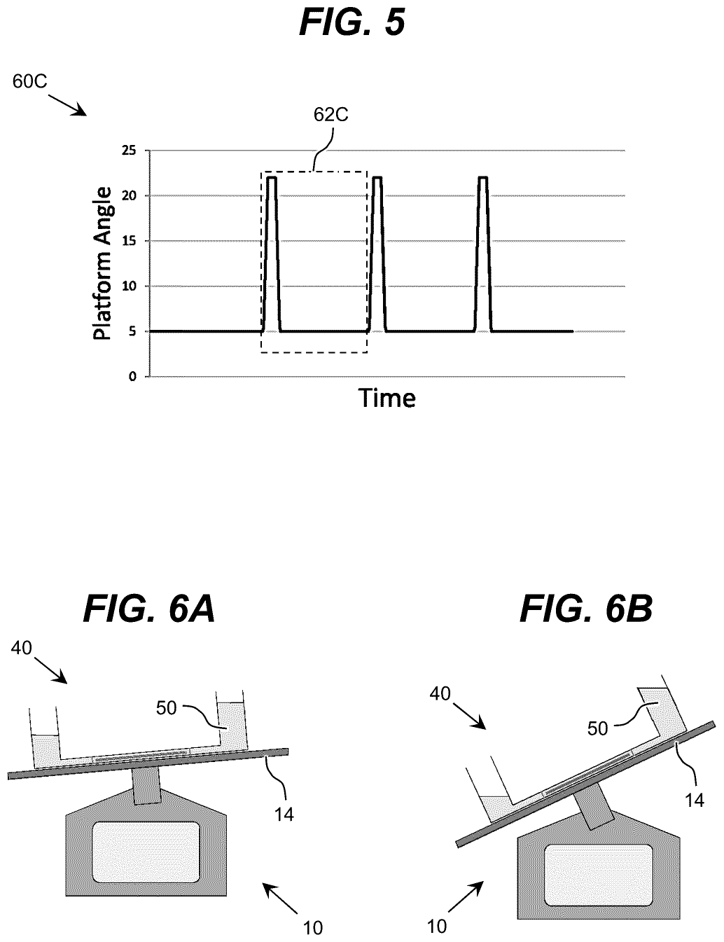

For example, FIG. 5 shows an illustrative tilt angle motion pattern 60C that can be implemented by a platform rocker device 10 according to another embodiment. In this case, the tilt angle motion pattern 60C is a pulsatile tilt motion, in which the tilt angle is rapidly, but only briefly, changed to a larger angle during each cycle 62C. FIGS. 6A and 6B show a platform rocker device 10 with a platform 14 held at two different tilt angles according to embodiments. To this extent, the tilt angle shown in FIG. 6A can correspond to a minimum tilt angle (e.g., approximately five degrees) which is maintained over an extended period of time as part of a cycle 62C of the pulsatile tilt motion pattern 60C shown in FIG. 5. The tilt angle shown in FIG. 6B can correspond to the maximum tilt angle (e.g., approximately twenty-two degrees) which is briefly maintained during each cycle 62C in the pulsatile tilt motion pattern 60C shown in FIG. 5.

Referring to FIGS. 5-6B, during each cycle 62C, the platform rocker device 10 adjusts the tilt angle of the platform 14 with pulsatile tilt motion. In this case, the platform rocker device 10 can maintain the platform 14 at a relatively shallow minimum tilt angle. Periodically, the platform rocker device 10 can change the tilt angle of the platform 14 to a steeper maximum tilt angle. The steeper maximum tilt angle can be maintained for a relatively short duration before the platform rocker device 10 returns the tilt angle of the platform 14 to the shallow minimum tilt angle. The cycle 62C can be repeated for any duration, e.g., number of cycles, time period, and/or the like.

A steeper tilt angle 56 of the platform 14 causes a greater difference in height 54 and the flow of the medium 50 through the structure 40 will be faster. So, pulsing the tilt angle 56 to steep angles causes the flow of the medium 50 to pulse. With the pulsatile tilt motion pattern 60C shown in FIG. 5, the rate of flow for the medium 50 within the structure 40 located on the platform 14 will pulse due to movement of the platform 14 between the shallow tilt tangle shown in FIG. 6A and the steep maximum tilt angle shown in FIG. 6B. Such motion can be used, for example, to mimic in vivo pulsatile flow, e.g., to simulate flow from a beating heart, peristalsis, and/or the like. In embodiments, the platform rocker device 10 can use inverted tilt angles after a number of cycles, e.g., to cause the medium 50 to flow with the pulsatile motion in a different direction.

It is understood that the pulsatile tilt motion pattern 60C and corresponding angles shown in FIGS. 5, 6A, and 6B are only illustrative of various possible tilt motion patterns and angles. For example, in embodiments, the shallow minimum tilt angle for the platform 14 can be in a range between approximately zero (e.g., a level platform) to an angle less than or equal to +/−ten degrees. The steep maximum tilt angle for the platform 14 can be a tilt angle that is more than approximately +/−ten degrees. Regardless, in embodiments, a difference between the steep maximum tilt angle and the shallow minimum tilt angle for the platform 14 can be greater than approximately ten degrees. However, it is understood that smaller differences can be utilized in embodiments.

As illustrated, FIG. 5 shows the time in arbitrary units. It is understood that the time between pulses and the duration of the pulses can be set to any desired durations. In embodiments, the time between pulses (e.g., the time that the platform 14 remains at the shallow minimum tilt angle) can be approximately one to two seconds. However, it is understood that these time intervals can be much larger, e.g., on the order of tens of seconds or minutes, or shorter, e.g., a tenth of a second. In embodiments, the duration of the pulse (e.g., the total time that the platform 14 is not at the shallow minimum tilt angle) is significantly less than the time between pulses. To this extent, in more particular embodiments the pulse can have a duration of less than one half a second. Regardless, it is understood that the time between pulses and the duration of the pulses can be selected based on attributes of the experiment being conducted (e.g., mimicking a heart rate of an animal) and the limitations of the equipment being used.

It is understood that various modifications can be made to the pulsatile tilt motion shown in FIG. 5. For example, in embodiments, the time between pulses can be altered, e.g., by increasing or decreasing the time between pulses during the duration of an experiment. Similarly, one or both of the shallow minimum tilt angle and steep maximum tilt angle can be altered during the duration of an experiment. For example, one or both tilt angles can be adjusted upward or downward for each pulse and period between pulses in the sequence, e.g., to accommodate a change in the difference in height 54 (FIG. 3B) due to the flow of the medium 50.

For long duration experiments, once the level of the medium 50 in the source well is too low, the platform rocker device 10 can invert the shallow minimum tilt angle and the steep maximum tilt angle so that the culture medium 50 flows in the opposite direction. To this extent, for the pulsatile tilt motion shown in FIG. 5, the platform rocker device 10 can adjust the shallow tilt angle to −5 degrees and the maximum tilt angle to −22 degrees. Such an adjustment can be done one or more times during the course of an experiment.

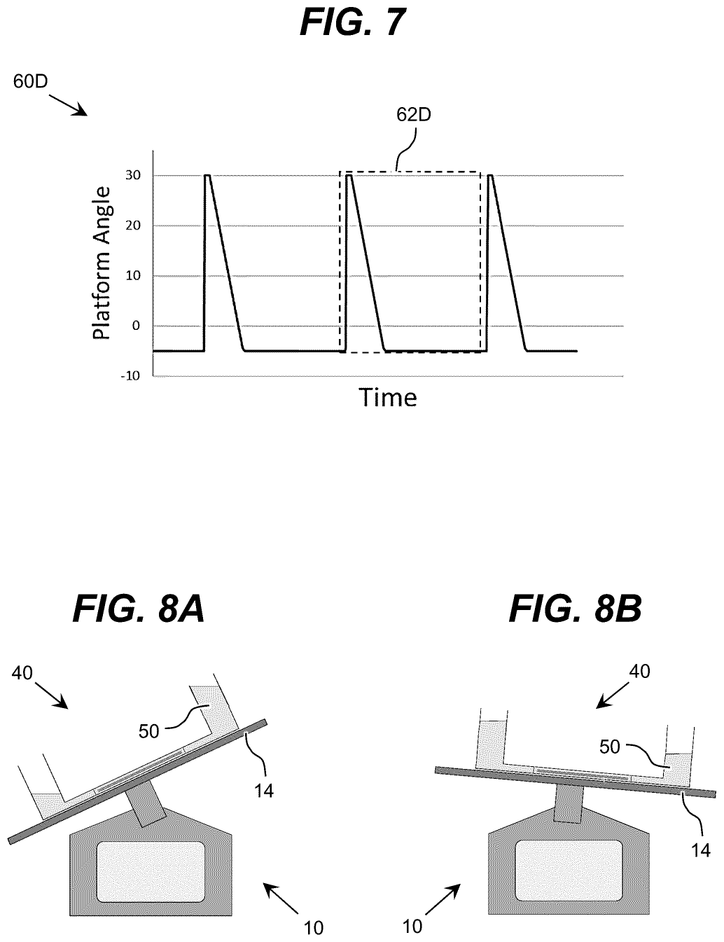

FIG. 7 shows another illustrative tilt angle motion pattern 60D according to an embodiment. FIGS. 8A and 8B show a platform rocker device 10 with a platform 14 held at two different tilt angles according to embodiments. For example, the tilt angle shown in FIG. 8A can correspond to a maximum tilt angle used in each periodic pulse of the cycles 62D shown in the pulsatile tilt motion pattern 60D of FIG. 7. The tilt angle shown in FIG. 8B can correspond to the shallow minimum tilt angle used in each cycle 62D shown in the pulsatile tilt motion pattern 60D of FIG. 7.

Referring to FIGS. 7-8B, each pulse of a cycle 62D is shown having a non-symmetric profile. For example, the platform rocker device 10 can change the angle of the platform 14 more rapidly when going from the shallow minimum tilt angle to the maximum tilt angle than when going from the maximum tilt angle back to the shallow minimum tilt angle.

Furthermore, FIGS. 7-8B illustrate an embodiment in which the flow of the medium is reversed as a result of the pulse in each cycle 62D. In this case, the shallow minimum tilt angle can cause the medium 50 to flow in a first direction at rate that is slower than a flow rate of the medium 50 in the opposite direction when the platform 14 is at the maximum tilt angle shown in FIG. 8A. As can be seen, e.g., due to a significant difference between the respective maximum and minimum tilt angles (e.g., approximately thirty and negative five, respectively), a rate of flow of the medium 50 in a first direction at the tilt angle shown in FIG. 8A will be higher than a rate of flow of the medium 50 in the opposite direction at the tilt angle shown in FIG. 8B. Such a pulse configuration can be used, for example, to culture cells with a shear flow of the medium 50 in one direction past the cell culture and a gentle flow of the medium 50 past the cell culture in the opposite direction. In embodiments, each cycle 62D can be configured such that approximately the same amount of the medium 50 flows in each direction during the cycle 62D.

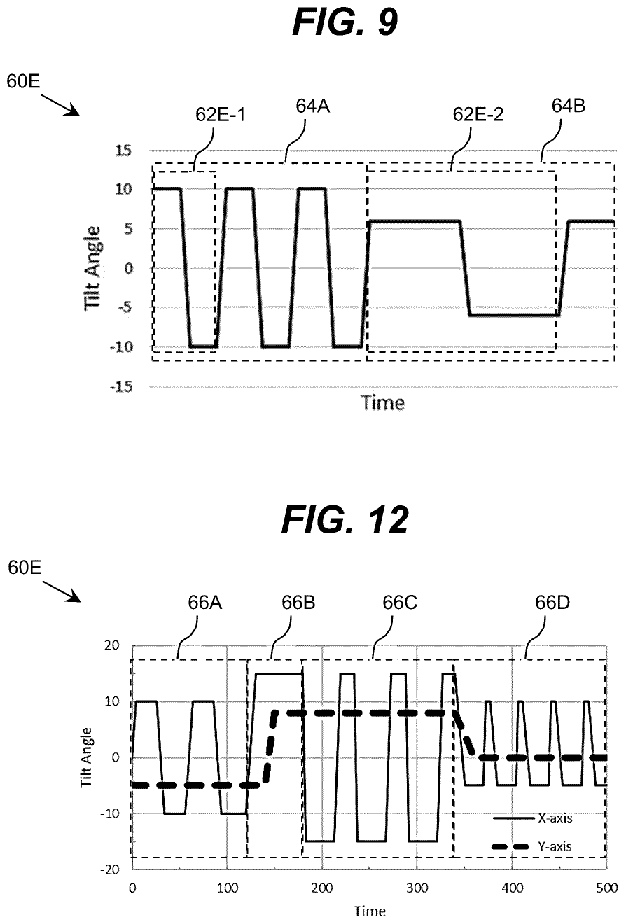

FIG. 9 shows an illustrative rocker motion according to an embodiment. In this case, during an experiment, the periodic motion is shown changing from a first pattern to a second pattern. The second pattern can include one or more attributes that differ from the first pattern. For example, the second pattern can differ by any combination of one or more of: the shallow tilt angle, the maximum tilt angle, the time at the shallow tilt angle, the time at the maximum tilt angle, the rate of change between the shallow tilt angle and the maximum tilt angle, the rate of change between the maximum tilt angle and the shallow tilt angle, etc. The difference(s) can result in an increase or a decrease to the corresponding attribute of the pattern. Such changes can result in, for example, changes to the culture medium flow rate as the cell culture progresses. Furthermore, it is understood that a cycle described herein can include any number of motions to any number of angles. For example, a cycle can include motions to one or more intermediate angles at which the platform 14 can remain for a period, a rate of change can be adjusted, and/or the like. To this extent, a cycle described herein can include any number of operations.

While various embodiments have been shown to illustrate the invention. It is understood that numerous variations are possible. Furthermore, it is understood that one or more attributes of the motion described in conjunction with one or more embodiments described herein can be combined and incorporated into one or more of the other embodiments in which such an attribute is not explicitly described.

For example, the very slow motion to compensate for a decreasing difference in volume between the source well and collection well shown in FIG. 4B can be incorporated into one or more of the other embodiments. More particularly, the very slow motion can be incorporated into the pulsatile motion shown in FIGS. 5 and 7. Such an incorporation can result in a slight increase in tilt angle over time to maintain the same base flow rate and peak flow rate of the culture medium. To this extent, in embodiments the corresponding graph can show a shallow tilt angle with a slight slope and peaks corresponding to the maximum tilt angle that trend to higher angles over time.

The platform rocker device 10 can adjust the tilt angle 54 of the platform 14 using any of various solutions. To this extent, embodiments of a platform rocker device described herein can use any of various alternative mechanisms to create the varying tilt angles. Such alternative mechanisms can implement the side to side motion of the arms that creates the varying tilt angles or can create the varying tilt angles using an alternative approach.

For example, an embodiment of a platform rocker device 10 can create varying tilt angles by selectively adjusting a height of a side of the platform 14 using a linear height adjustment solution. Illustrative linear height adjustment components comprise a linear actuator, a stepper motor with a threaded rod (e.g., a rotary motor), a motorized telescoping pole, and/or the like.

FIG. 10 shows another illustrative configuration for creating tilt angle motion patterns according to embodiments. In this case, the platform 14 is movably mounted to a base platform 70. In particular, the platform 14 is shown mounted to the base platform 70 using a pair of flexible mounts 74A, 74B, and a pair of extendible mounts 76A, 76B. The flexible mounts 74A, 74B are shown located adjacent to two corners of a side of the platform 14, while the extendible mounts 76A, 76B are shown located adjacent to two corners of the opposite side of the platform 14. The base platform 70 can, for example, form a bottom or an upper surface of a base, such as the base 12 shown in FIG. 2.

In embodiments, the flexible mounts 74A, 74B can be formed of any suitable material that provides a mounting surface that is firm but can accommodate movement of the platform 14. For example, the flexible mounts 74A, 74B can be formed of rubber which is placed between the base platform 70 and the platform 14, with an extension that can be inserted through complementary openings in the base platform 70 and/or the platform 14. However, it is understood that any suitable material and/or comparable mounting solution can be utilized.

The opposing side of the platform 14 is shown mounted using a pair of extendible mounts 76A, 76B. The extendible mounts 76A, 76B can be operated together by a control component (such as the control component 20 shown in FIG. 2) in order to create any of a plurality of tilt angles for the platform 14. In an embodiment, an extendible mount 76A, 76B includes an arm, such as a threaded arm 78A, 78B, which can be affixed to the base platform 70 (e.g., using a swivel mounting solution) and a motor housing 79A, 79B mounted to the platform 14. Operation of a motor located in the motor housing 79A, 79B can cause the extendible mount 76A, 76B to selectively move up or down along the threaded arm 78A, 78B, thereby creating a desired tilt angle. While the motor housings 79A, 79B are illustrated as being mounted to a top surface of the platform 14, it is understood that this is only illustrative and the motor housings 79A, 79B can be alternatively mounted on a bottom surface of the platform 14, a top surface of the base platform 70, and/or the like.

It is understood that the configuration shown in FIG. 10 is only illustrative of numerous possible configurations in which one or more linear height adjustment components are utilized. For example, in embodiments, a platform 14 can be mounted to linear height adjustment components, such as the extendible mounts 76A, 76B, which are located on two opposing sides of the platform 14. More particularly, the platform 14 can be mounted in a manner similar to the mounting used for the two arms shown in FIG. 2, but with the linear height adjustment components located on opposing sides of the platform 14 instead of the front and back arrangement described in conjunction with the two arms shown in FIG. 2. Regardless, in this configuration, the control component 20 can individually operate each linear height adjustment component to extend or retract the corresponding linear height adjustment component to create a desired tilt angle for the platform 14 as described herein.

Alternative embodiments can be implemented using a single linear height adjustment component, such as one of the extendible mounts 76A, 76B, which can be located in an approximate center of a side of the platform 14. In this case, as with the configuration shown in FIG. 10, the tilt angle of the platform 14 can be at a maximum or minimum tilt angle when the linear height adjustment component is fully retracted, while the tilt angle of the platform 14 is at the other of the maximum or minimum tilt angle when the linear height adjustment component is fully extended. To this extent, in embodiments, the base platform 70 may be located at a negative tilt angle.

In even further other embodiments, four linear height adjustment components can be utilized. In this case, the platform 14 can be mounted to a linear height adjustment component located adjacent to each corner. For example, for the embodiment shown in FIG. 10, each flexible mount 74A, 74B can be replaced with an extendible mount 76A, 76B. The control component 20 can be configured to operate the linear height adjustment components in pairs, or can operate each of the linear height adjustment components independently. In the latter case, the control component 20 can operate the linear height adjustment components to ensure that the platform 14 is substantially level along a front to back axis of the platform 14, while also forming various tilt angles along a side to side axis of the platform 14.

In embodiments, the platform rocker device 10 can adjust tilt angles of the platform 14 along two or more axes during a process. In embodiments, the two axes are perpendicular to each other. For example, using the configuration of four linear actuators operated independently described above, the control component 20 can operate the linear actuators to adjust both a side to side tilt angle as well as a front to back tilt angle during a process. The control component 20 can operate the linear actuators to adjust the respective tilt angles during a process using a series of cycles. The side to side tilt angle cycles can be defined independently of the front to back tilt angle cycles. For example, a structure 40 (FIGS. 3A-3D) may be designed for the medium 50 (FIGS. 3A-3D) to progress from section to section by tilting the structure 40 along a second axis. Tilting along a second axis also can enable the medium 50 in the structure 40 to follow a different path, e.g., depending on a direction of flow caused by the tilt angle along the first axis. In such a configuration, the medium 50 can travel in a circular path, which can allow for flow only in one direction past a culture 52 (FIGS. 3A, 3B) which can be located on only one of the flow paths, rather than in two directions back and forth.

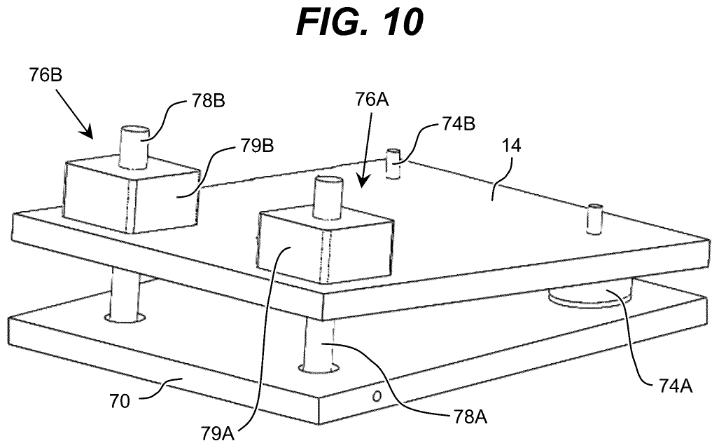

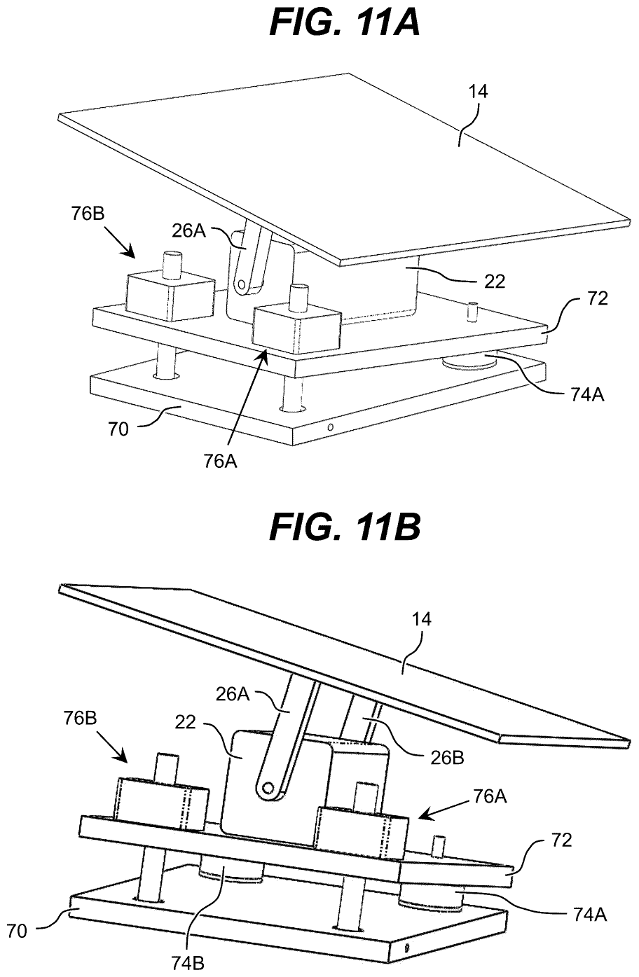

FIGS. 11A and 11B show another illustrative configuration for creating tilt angles for a platform along two axes according to embodiments. In this case, the platform 14 is shown mounted to a pair of arms 26A, 26B, which can be operated by a motor 22 as described herein to create tilt angles along a first axis. The motor 22 is shown mounted to a sub-platform 72, which can be movably mounted to a base platform 70. In the illustrated configuration, the sub-platform 72 is mounted to the base platform 70 in the same manner as shown and described in conjunction with the platform 14 illustrated in FIG. 10 to create the tilt angles along a second axis.

As discussed herein, creating the desired tilt angles can be performed independently of each other during a process. The two motions can be coordinated, yet occur at different rates, angles, times, etc. Embodiments can use separate motors to control the motion about each axis, with the operation of each motor controlled by a single control unit 20 (FIG. 2). To this extent, FIG. 12 shows an illustrative two axis tilt angle motion pattern, which can be implemented for the platform 14 shown in FIGS. 11A and 11B according to embodiments. As illustrated, the platform 14 can be moved along a first axis (e.g., x-axis) to create a first series of tilt angles over time during a process. Concurrently and independently of the tilt angles formed along the first axis, the platform 14 can be moved along a second axis (e.g., y-axis) to create a second series of tilt angles over time during the process.

While each series of tilt angles are shown having differing angles, times, movement velocities, etc., it is understood that these differences are only illustrative. In embodiments, some or all of a process described herein can include movement along both axes that is synchronized in one or more aspects, such as angles, times, movement velocities, and/or the like.

As discussed herein, a process can be defined using any solution. In embodiments, a user can define the process using a user interface, such as the user interface 18 shown in FIGS. 1 and 2. For example, in embodiments a user can define a process using a graphical interface, such as those shown in FIGS. 4A-5, 7, 9, and 12. In embodiments, the user interface 18 can enable the user to define the motions as a series of stages, with each stage having one or more steps, which are repeated one or more times for a timed duration (e.g., number of repetitions, seconds, and/or the like). The control unit 20 (FIG. 1) can store the defined motions as process data, which can be utilized by the control unit 20 to perform the process.

In the example shown in FIG. 12, during an initial stage 66A, which lasts for 120 seconds, the platform 14 is alternated between two tilt angles about the x-axis. In the next stage 66B, the tilt angle for the x-axis is changed to a steeper angle, and the tilt angle for the y-axis is also changed, followed by a pause. A third stage 66C includes rocking along the x-axis with asymmetric pauses and lasts for 160 seconds. A final stage 66D, includes asymmetric rocking tilt angles, speeds, and pauses along the x-axis, a change in tilt angle along the y-axis, and continues through the remainder of the illustrated tilt motion pattern.

For each stage, the user can define a series of steps, with each step including a target tilt angle for the platform 14 and a rate of change when transitioning from a current tilt angle to the target tilt angle. It is understood that the rate of change can be expressly defined by the user or inferred from other data defined by the user for the step. For example, in embodiments the user can define a duration for the transition, from which a required rate of change can be calculated. Similarly, the user can define a time a transition should start and a time by which the target angle should be reached, from which a duration and/or a rate of change can be calculated.

Furthermore, a step can include a duration of a pause for which the platform should remain at the target tilt angle. In embodiments, the duration of the pause can be expressly or implicitly defined. In the latter case, the pause can be determined based on an amount of time until a next step is specified to occur. In embodiments, the pause can be zero, that is, the platform continues to move (e.g., at a slower rate, in an opposite direction, and/or the like), after arriving at the target tilt angle.

For a stage, one or more steps can be defined as a cycle, where a cycle is repeated one or more times during the stage. In embodiments, a user can expressly define a cycle or a cycle can be inferred from the steps defining a corresponding stage. For example, a duration of a stage can be defined as a number of times to repeat the steps of the stage, which can be collectively defined as a single cycle. Alternatively, a duration for a stage can be defined as a fixed amount of time, and a number of cycles (e.g., a number of repetitions of the steps) can be determined by the time it takes to complete all of the steps. In this case, a stage may include a fractional cycle.

In embodiments, when the platform can be moved along multiple axes, each step can include the target tilt angle and a corresponding rate of change for each axis. To enable non-synchronized movement along each axis, a step can include an indication that one or more of the values for an axis are to remain unchanged. The computer system can use any solution for enabling such an indication by the user.

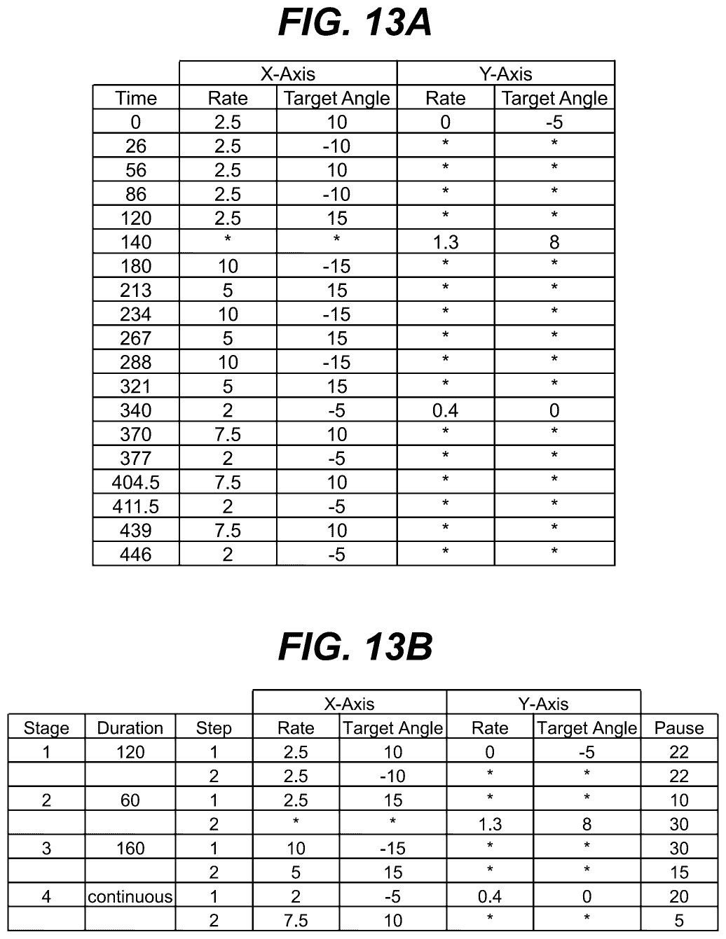

The control component 20 (FIG. 1) can store process data defining a process using any suitable solution. For example, FIGS. 13A and 13B show illustrative process data defining a process including motion between two axis tilt angles according to embodiments. The process data in FIGS. 13A and 13B can define the same tilt angle motion, both of which correspond to the tilt angle motion shown in FIG. 12.

In FIG. 13A, the process data includes entries defining a target tilt angle for each axis at a particular time as well as a speed at which the tilt angle for one or both axes should be changed to the corresponding target tilt angle. In this case, the control component 20 can initiate the specified motion at the corresponding time. Once the target tilt angle is reached, the control component 20 can stop the motion and pause at the given time until the next change is specified. As illustrated, an entry can include a non-numeric indication, such as a “*”, which can indicate that a current value for the entry is to remain unchanged.

In FIG. 13B, the process is defined as multiple stages, with each stage having a designated duration (e.g., cycles or time) and including a number of steps. A step is defined as a transition from a current tilt angle to a target tilt angle at a designated rate of change (e.g., speed), which can be followed by a pause for a certain duration, a change in the rate of change, a change of target angle, and/or the like. Once a step is completed, the control component 20 can execute the next step in the stage. If the step is the last step in the stage, the control component 20 can return and execute the first step in the stage, until the duration for the stage has completed. As illustrated, a process, or a stage thereof, can include a duration that has an undefined stop time. In this case, an entry for the duration can include an indication (e.g., “continuous”) that the steps are to be repeated until a user halts the process.

It is understood that FIGS. 13A and 13B and the data shown therein are only illustrative of various suitable solutions for defining a process. In embodiments, a rate of change used to transition between two tilt angles can be non-linear, i.e., vary during the transition. For example, the rate of change can be defined using a mathematical function or the like, which defines a non-linear speed for a transition from a first tilt angle to a second tilt angle. Similarly, a plurality of steps of a stage can be defined using a single mathematical function. For example, the mathematical function can correspond to half of a sine wave, which results in transitions from a first angle to a second angle and back to the first angle.

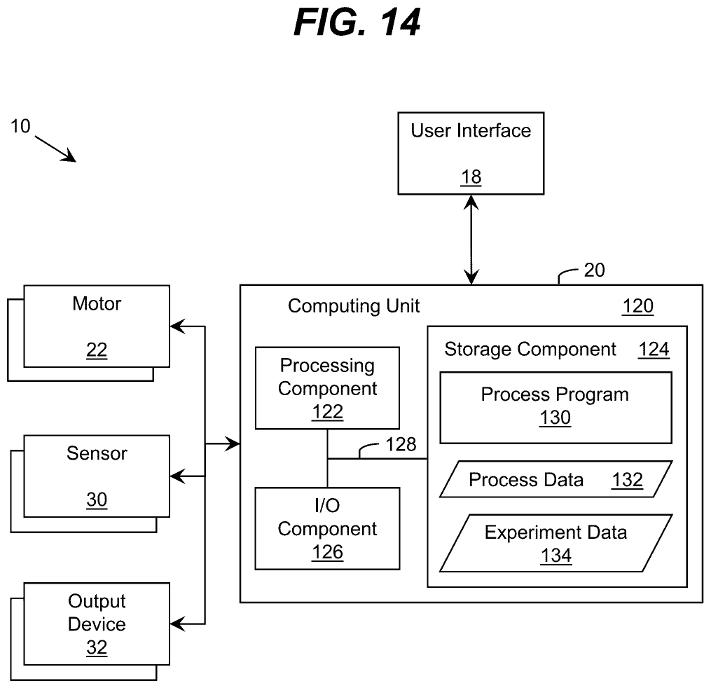

FIG. 14 shows a schematic of various components of an illustrative platform rocker device 10 according to embodiments. As discussed herein, the platform rocker device 10 can include a control component 20, which can perform a process including directing movement of a platform 14 (FIGS. 1, 10, 11A-11B) to various tilt angles over time. To this extent, the platform rocker 10 can further include a user interface 18 which enables a user (human or a computing device) to provide instructions to the control component 20 regarding the process, such as selecting an available process, defining a new process, etc., and receive information regarding the process, such as current tilt angle(s), current duration, time remaining, time remaining for a current step, cycle, and/or stage, etc.

When available, such instructions and information provided by and to the user also can include instructions and/or information regarding other aspects of the process. For example, the user can define one or more settings for an ambient environment, such as a temperature, lighting, a gas, liquid, chemical, and/or the like, treatment, and/or the like, which the control component 20 can perform during the process using one or more output devices 32. The control component 20 can receive and provide information on the tilt angle(s), various attributes of the ambient environment, etc., using data acquired by one or more sensors 30, data provided by a motor 22, data provided by an output device 32, and/or the like.

The control component 20 is shown implemented as a computing unit 120 which includes a processing component 122 (e.g., one or more processors), a storage component 124 (e.g., a storage hierarchy), an input/output (I/O) component 126 (e.g., one or more I/O interfaces and/or devices), and a communications pathway 128. The processing component 122 can execute a process program 130, which can include instructions that make the computing unit 120 operable to perform a process described herein. The process program 130 can use process data 132 to determine one or more actions to be implemented while performing the process. Data acquired while performing the process can be stored as experiment data 134, which can be provided for use by a user using the user interface 18.

It is understood that the computing unit 120 and the process program 130 are only representative of various possible equivalent computer systems that may perform a process described herein. To this extent, in other embodiments, the functionality provided by the computing unit 120 and the process program 130 can be at least partially implemented by one or more computing devices that include any combination of general and/or specific purpose hardware with or without program code. In each embodiment, the hardware and program code, if included, can be created using standard engineering and programming techniques, respectively.

It is understood that the processes and tilt motions shown and described herein are only illustrative. In each case, a duration of a process and a corresponding number of cycles, steps, repetitions of steps, stages, etc., can be much larger for a given process.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

It is understood that, unless otherwise specified, each value is approximate and each range of values included herein is inclusive of the end values defining the range. Terms of degree such as “generally,” “substantially,” “about,” and “approximately” as used herein mean a reasonable amount of deviation of the modified term such that the end result is not significantly changed. For example, these terms can be construed as including a deviation of at least +/−0.5% of the modified term if this deviation would not negate the meaning of the word it modifies.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A device comprising:
a base;
a tiltable platform mounted to the base; and
a control unit configured to direct movement of the tiltable platform in a specified pattern as part of a process, wherein the specified pattern includes settings corresponding to each of a plurality of steps, each step having user selectable settings including a target tilt angle and a rate of change when transitioning from a current tilt angle to the target tilt angle, wherein the user selectable settings are independently selectable for each step.

2. The device of claim 1, wherein the tiltable platform is mounted to the base via a set of arms, each arm of the set of arms being capable of rotation over a range of possible tilt angles along a first axis.

3. The device of claim 1, wherein the base includes a motor, wherein the control unit operates the motor to direct the movement of the tiltable platform.

4. The device of claim 1, further comprising an interface configured to enable a user to define the user selectable settings for each of the plurality of steps of the specified pattern.

5. The device of claim 1, further comprising a sensor configured to acquire tilt data corresponding to a current tilt angle for the tiltable platform, wherein the control unit uses the tilt data to direct the movement of the tiltable platform in the specified pattern.

6. The device of claim 1, wherein the specified pattern includes at least one step having a non-linear rate of change for a transition between tilt angles.

7. The device of claim 1, wherein the specified pattern includes a plurality of stages, wherein a first stage of the plurality of stages includes a first plurality of steps having at least one user selectable setting that differs from a corresponding at least one user selectable setting of a second plurality of steps for a second stage of the plurality of stages.

8. The device of claim 1, wherein at least one step of the specified pattern defines a transition between a first tilt angle and a second tilt angle having a rate of change configured to compensate for a change in a difference in height between an upper surface of a medium located in a first well and an upper surface of the medium located in a second well due to flow of the medium between the first well and the second well.

9. The device of claim 1, wherein at least a portion of the specified pattern defines pulsatile tilt motion of the tiltable platform.

10. The device of claim 1, wherein the specified pattern includes a first transition between a first tilt angle and a second tilt angle and a second transition from the second tilt angle to the first tilt angle, wherein the first and second transitions have different durations.

11. The device of claim 1, wherein the specified pattern includes a plurality of stages, the plurality of stages including a first stage having a first periodic motion pattern and a second stage having a second periodic motion pattern, wherein the first and second periodic motion patterns differ by at least one of: a first tilt angle, a second tilt angle, a duration of transitions between first and second tilt angles, or a dwell duration at at least one of the first or second tilt angles.

12. A device comprising:
a base;
a tiltable platform mounted to the base, wherein the tiltable platform is configured to support at least one structure including a pair of wells and a channel enabling flow of a medium between the pair of wells; and
a control unit configured to direct movement of the tiltable platform in a specified pattern as part of a process, wherein the specified pattern includes a plurality of steps configured to affect the flow of the medium in the channel during the process, the plurality of steps including:
a first step having a first starting tilt angle, a first target tilt angle, and a first rate of change when transitioning from the first starting tilt angle to the first target tilt angle; and
a second step having a second starting tilt angle, a second target tilt angle, and a second rate of change when transitioning from the second starting tilt angle to the second target tilt angle;
wherein at least one of: the first starting tilt angle differs from the second target tilt angle, the first target tilt angle differs from the second starting tilt angle, or the first rate of change differs from the second rate of change.

13. The device of claim 12, wherein at least one step of the plurality of steps includes a non-linear rate of change for a transition between tilt angles.

14. The device of claim 12, wherein the specified pattern includes a plurality of stages, wherein a first stage of the plurality of stages includes a first plurality of steps having at least one user selectable setting that differs from a corresponding at least one user selectable setting of a second plurality of steps for a second stage of the plurality of stages.

15. The device of claim 12, wherein at least one of the plurality of steps of the specified pattern defines a transition between a first tilt angle and a second tilt angle having a rate of change configured to compensate for a change in a difference in height between an upper surface of the medium located in a first well of the pair of wells and an upper surface of the medium located in a second well of the pair of wells due to flow of the medium between the first well and the second well.

16. The device of claim 12, wherein at least a portion of the specified pattern defines pulsatile tilt motion of the tiltable platform.

17. The device of claim 12, wherein the specified pattern includes a first transition between a first tilt angle and a second tilt angle and a second transition from the second tilt angle to the first tilt angle, wherein the first and second transitions have different durations.

18. The device of claim 12, wherein the specified pattern includes a plurality of stages, the plurality of stages including a first stage having a first periodic motion pattern and a second stage having a second periodic motion pattern, wherein the first and second periodic motion patterns differ by at least one of: a first tilt angle, a second tilt angle, a duration of transitions between first and second tilt angles, or a dwell duration at at least one of the first or second tilt angles.

19. A method of performing a process, the method comprising:
a control unit directing movement of a tiltable platform supporting a structure in a specified pattern as part of the process, the structure including a pair of wells and a channel enabling flow of a medium between the pair of wells;
wherein the specified pattern includes a plurality of steps configured to affect the flow of the medium in the channel during the process, the plurality of steps including:
a first step having a first starting tilt angle, a first target tilt angle, and a first rate of change when transitioning from the first starting tilt angle to the first target tilt angle; and
a second step having a second starting tilt angle, a second target tilt angle, and a second rate of change when transitioning from the second starting tilt angle to the second target tilt angle;
wherein at least one of: the first starting tilt angle differs from the second target tilt angle, the first target tilt angle differs from the second starting tilt angle, or the first rate of change differs from the second rate of change.

20. The method of claim 19, wherein at least a portion of the specified pattern defines pulsatile tilt motion of the tiltable platform.
